(19) United States
(12) Patent Application Publication
(10) Pub. No.: US 2025/0155233 A1
(43) Pub. Date: May 15, 2025

(54) MAGNETIC ENCODER

(71) Applicant: Mitsubishi Electric Corporation, Tokyo (JP)

(72) Inventors: Akira HOTTA, Tokyo (JP); Takeshi MUSHA, Tokyo (JP)

(73) Assignee: Mitsubishi Electric Corporation, Tokyo (JP)

(21) Appl. No.: 18/837,930

(22) PCT Filed: Mar. 7, 2022
(86) PCT No.: PCT/JP2022/009763

§ 371 Date: Aug. 13, 2024

(51) Int. Cl. G01B 7/30; H02K 11/215

(52) U.S. Cl. CPC G01B 7/30; H02K 11/215

(57) ABSTRACT

A magnetic encoder includes a magnetic scaler and a position detector that move relative to each other. The magnetic scaler includes a magnet group where at least three magnets having the same magnetization direction are arranged in an x-direction and a magnet group where at least three magnets, each having an opposite magnetization direction, are arranged in the x-direction, with the magnet group being adjacent to the magnet group in the x-direction. The position detector includes a magnetic sensor that detects a magnetic field generated from the magnetic scaler. In the magnet group, magnet widths increase from ends to a middle of the magnet group and are each smaller than a magnet pitch. In the magnet group, magnet widths increase from ends to a middle of the magnet group and are each smaller than the magnet pitch.

### FIELD

The present disclosure relates to a magnetic encoder including a magnetic detector and a position detector that move relative to each other.

### BACKGROUND

A magnetic encoder includes a magnetic detector and a position detector that move relative to each other. Such a magnetic encoder finds use as a rotary encoder, which is a rotation detector used to control a rotary servomotor, a linear encoder, which is a position detector used to control a linear motor, or the like.

Patent Literature 1 discloses a magnetic scaler with pluralities of magnetic poles. The magnetic scaler includes a magnetic pole arrangement that is the plurality of magnetic poles of the same polarity spaced apart at equal pitches. The spacing between the magnetic poles is greater than a magnetic-pole width measured in an arrangement direction and less than twice the magnetic-pole width in the arrangement direction. A magnetic sensor outputs varied magnetic fields of the magnetic scaler as an electric signal, and position data are obtained from voltage peaks.

### CITATION LIST

### Patent Literature

Patent Literature 1: Japanese Patent Application Laid-open No. 2001-227904

### SUMMARY OF INVENTION

### Problem to be Solved by the Invention

According to Patent Literature 1, same-polarity widths of plural magnets are all the same, thus leading to a problem that only peak positions of the magnetic fields and the discrete position data corresponding to the peak positions are obtained.

The present disclosure has been made in view of the above, and an object of the present disclosure is to obtain a magnetic encoder that is capable of obtaining a smooth, long-period sinusoidal signal, allowing for acquisition of continuous and highly accurate position data over a wide range.

### Means to Solve the Problem

In order to solve the above-stated problem and achieve the object, a magnetic encoder according to the present disclosure includes a magnetic scaler and a position detector configured to move relative to each other. The magnetic scaler includes a first magnet group where at least three magnets having an identical first magnetization direction are arranged in a first direction, and a second magnet group where at least three magnets, each having a second magnetization direction opposite to the first magnetization direction, are arranged in the first direction. The second magnet group is adjacent to the first magnet group in the first direction. The position detector includes a magnetic sensor configured to detect a magnetic field generated from the magnetic scaler. In the first magnet group, magnet widths are configured to increase from ends to a middle of the first magnet group, and each of the magnet width is smaller than a magnet pitch. In the second magnet group, magnet widths are configured to increase from ends to a middle of the second magnet group, and each of the magnet width is smaller than the magnet pitch.

### Effect of the Invention

The magnetic encoder according to the present disclosure has an effect of obtaining a smooth, long-period sinusoidal signal, allowing for acquisition of continuous and highly accurate position data over a wide range.

### BRIEF DESCRIPTION OF DRAWINGS

FIG. 1 is a perspective view of a magnetic encoder according to a first embodiment.

FIG. 2 is a perspective view of the magnetic encoder according to the first embodiment, not illustrating an upper part of a base body.

FIG. 3 is a front view of the magnetic encoder according to the first embodiment.

FIG. 4 is an enlarged front view illustrating how magnets are arranged in magnet groups of the magnetic encoder according to the first embodiment.

FIG. 5 is a front view of a magnetic scaler as a comparative example.

FIG. 6 is a diagram illustrating a waveform of magnetic flux density applied to a magnetic detection element from the magnetic scaler, which is the comparative example.

FIG. 7 is a diagram illustrating a waveform of magnetic flux density applied to magnetic sensors from a magnetic scaler of the magnetic encoder according to the first embodiment.

FIG. 8 is a front view illustrating a configuration of a magnetic encoder according to a second embodiment.

FIG. 9 is a diagram illustrating waveforms of magnetic flux density applied to a magnetic sensor from a magnetic scaler of the magnetic encoder according to the second embodiment.

FIG. 10 is an enlarged front view illustrating a configuration of a magnetic scaler of a magnetic encoder according to a third embodiment.

FIG. 11 is an enlarged front view illustrating a configuration of a magnetic scaler of a magnetic encoder according to a fourth embodiment.

FIG. 12 is a perspective view illustrating a configuration of a magnetic encoder according to a fifth embodiment.

### DESCRIPTION OF EMBODIMENTS

With reference to the drawings, a detailed description is hereinafter provided of magnetic encoders according to embodiments.

### First Embodiment

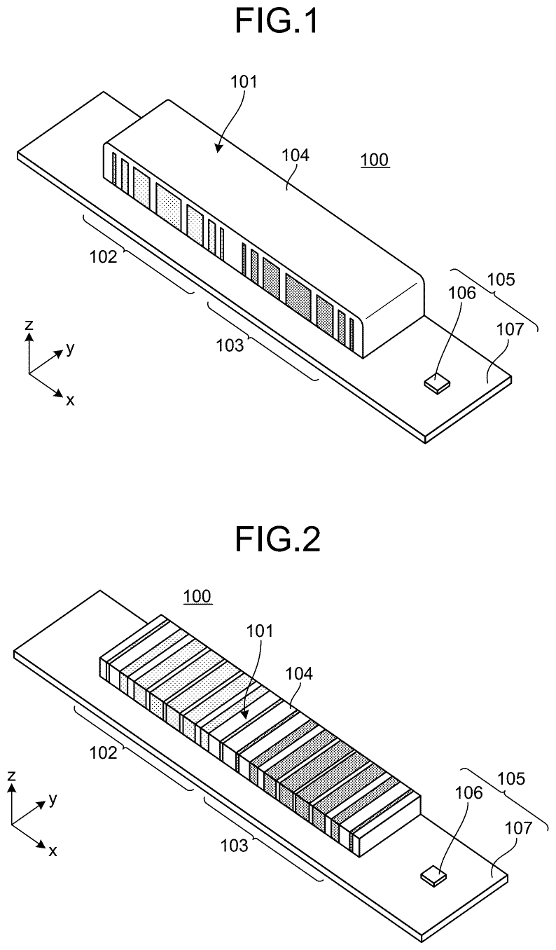

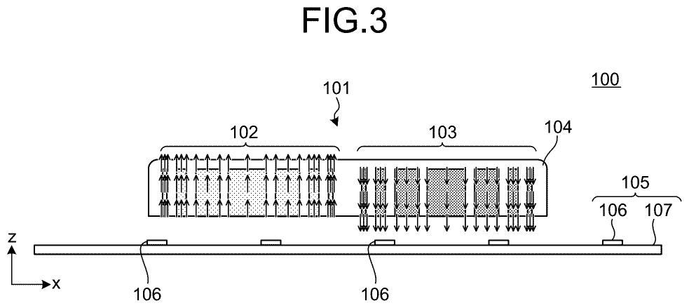

FIG. 1 is a perspective view of a magnetic encoder according to a first embodiment. FIG. 2 is a perspective view of the magnetic encoder according to the first embodiment, not illustrating an upper part of a base body. FIG. 3 is a front view of the magnetic encoder according to the first embodiment. In FIG. 2, a part of the base body 104 that is located above magnet groups 102 and 103 is not illustrated to make clearer how magnets are arranged.

The magnetic encoder 100 according to the first embodiment includes a magnetic scaler 101 and a position detector 105 that detects magnetic fields generated from the magnetic scaler 101. The magnetic encoder 100 according to the first embodiment is a linear encoder. The magnetic scaler 101 includes: the magnet group 102 as a first magnet group; the magnet group 103 as a second magnet group; and the base body 104 that is made of a nonmagnetic material and holds the magnet groups 102 and 103 in place. The position detector 105 includes: a plurality of magnetic sensors 106 that detect the magnetic fields generated from the magnetic scaler 101; and a substrate 107 on which the magnetic sensors 106 are installed. FIGS. 1 to 3 illustrate three-dimensional directions denoted by x, y, and z. The x-direction corresponds to a direction along which the magnetic scaler 101 moves; the z-direction corresponds to a direction in which the position detector 105 faces the magnetic scaler 101; and the y-direction is a direction perpendicular to the x-direction and the z-direction. In the present disclosure, in the case of the linear encoder, the x-direction corresponds to a first direction.

The magnetic scaler 101 and the position detector 105 move relative to each other. In the first embodiment, the magnetic scaler 101 is a mover that moves along the x-direction. The position detector 105 is a stator fixed at a given distance from the magnetic scaler 101 in a z-direction. The position detector 105 detects a position of the magnetic scaler 101 on the basis of the magnetic fields that shift as the magnetic scaler 101 passes by.

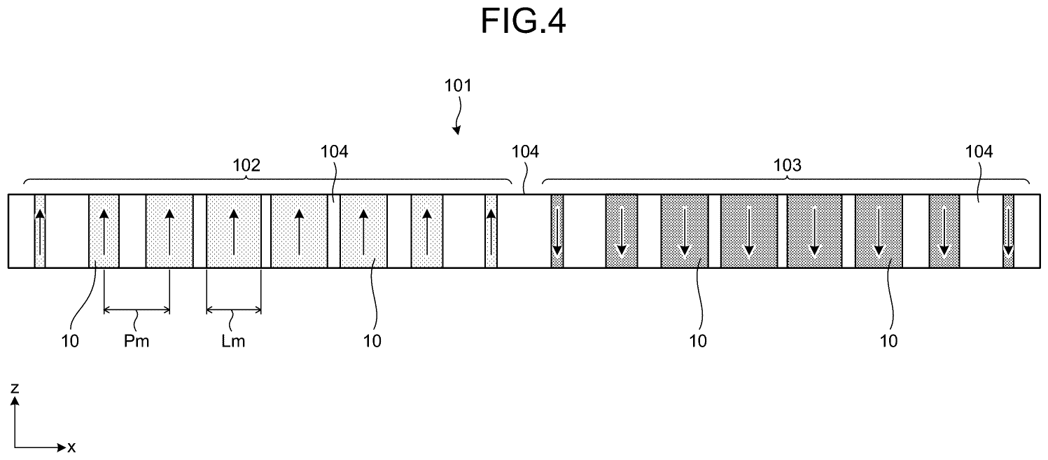

FIG. 4 is an enlarged front view illustrating how the magnets are arranged in the magnet groups 102 and 103 of the magnetic encoder 100 according to the first embodiment. For the magnetic encoder 100 of the first embodiment that is illustrated in FIGS. 1 to 4, a magnet-width modulation method by which magnet widths Lm vary is used. Arrows in the magnets illustrated in FIGS. 3 and 4 indicate internal magnetization directions after magnetization. Each of the arrows has a pointed end indicating a north pole and a base end indicating a south pole. Therefore, every magnet 10 in the magnet group 102 has the south pole on its side facing the position detector 105. Every magnet 10 in the magnet group 103 has the north pole on its side facing the position detector 105. The internal magnetization direction of each magnet is hereinafter referred to simply as the magnetization direction. Thus the magnets 10 constituting the magnet group 102 are all magnetized in a first magnetization direction, and the magnets 10 constituting the magnet group 103 are all magnetized in a second magnetization direction opposite to the first magnetization direction.

The magnet groups 102 and 103 have the same number of magnets 10, which is at least three. A magnet pitch Pm is constant. The magnet pitch Pm is a pitch at which the magnets 10 are arranged and refers to a distance between centerlines of any two magnets 10 adjacent in the x-direction. The magnet widths Lm increase and decrease according to a sin function that refers to a sinusoidal function. In other words, the magnet widths Lm increase from ends to a middle of each of the magnet groups 102 and 103 with respect to the x-direction. Put differently, the magnet widths Lm gradually increase and then gradually decrease in each of the magnet groups 102 and 103. However, each of the magnet widths Lm is smaller than the magnet pitch Pm. In other words, even the greatest magnet width Lm is smaller than the constant magnet pitch Pm.

As illustrated in FIG. 4, the magnets 10 constituting the magnet group 102 are eight in number. The magnets 10 constituting the magnet group 103 are also eight in number. A total of sixteen magnets 10 are arranged at the same magnet pitch Pm. A position −Pm/2 away in an x-direction from the magnet 10 that is installed farthest from the magnet group 103 among the magnets 10 constituting the magnet group 102, namely a left edge of the magnetic scaler 101 illustrated in FIG. 4, corresponds to 0 degrees of the sin function. A position Pm/2 away in the x-direction from the magnet 10 that is installed farthest from the magnet group 102 among the magnets 10 constituting the magnet group 103, namely a right edge of the magnetic scaler 101 illustrated in FIG. 4, corresponds to 360 degrees of the sin function.

In FIG. 4, the eight magnets 10 in the magnet group 102 are arranged at the magnet pitch Pm; this corresponds to arranging these magnets 10 at a pitch of 22.5 degrees, starting from 11.25 degrees of the sin function. The eight magnets in the magnet group 102 correspond to a range from 0 degrees to 180 degrees of the sin function, and each of their respective magnet widths Lm is defined by a value obtained by multiplying an integral over a corresponding one of 22.5-degree divisions (eight equal parts) of the sin function by a constant. The eight magnets 10 in the magnet group 103 are similarly arranged at the magnet pitch Pm; this corresponds to arranging these magnets 10 at the pitch of 22.5 degrees, starting from 191.25 degrees of the sin function. The eight magnets 10 in the magnet group 103 correspond to a range from 180 degrees to 360 degrees of the sin function, and each of their respective magnet widths Lm is defined by a value obtained by multiplying an integral over a corresponding one of 22.5-degree divisions (eight equal parts) of the sin function by a constant. Thus the magnet groups 102 and 103 each has, in the x-direction, a length corresponding to a half wavelength of a desired sinusoidal waveform.

As illustrated in FIG. 3, the plurality of magnetic sensors 106 of the position detector 105 are arranged on the substrate 107 at equal pitches in the x-direction. The pitch at which the magnetic sensors 106 are arranged is set to be less than or equal to the wavelength of the sinusoidal waveform, which is formed by the magnetic scaler 101, to prevent generation of areas where position detection is not possible.

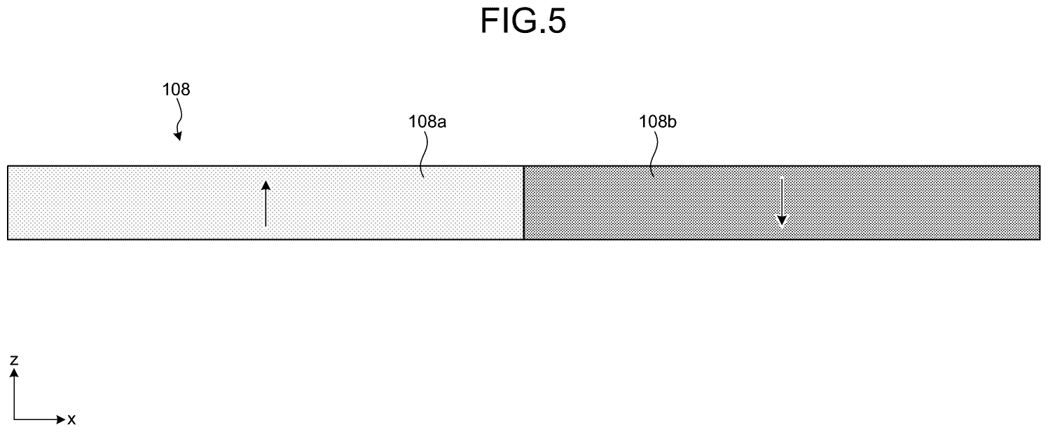

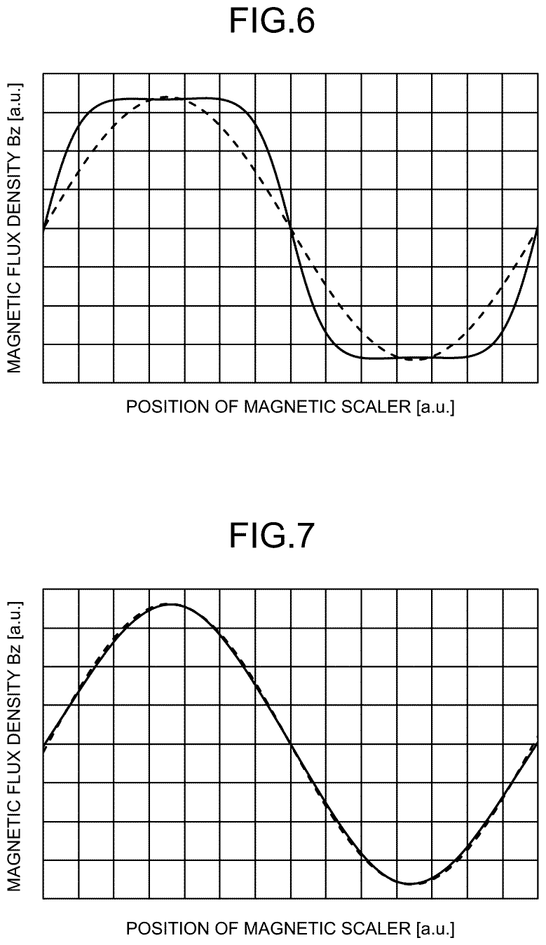

FIG. 5 is a front view of a magnetic scaler as a comparative example. FIG. 6 is a diagram illustrating a waveform of magnetic flux density applied to a magnetic detection element from the magnetic scaler, which is the comparative example. The magnetic scaler 108, which is the comparative example, has magnets 108a and 108b that are long in the x-direction, with no magnet-width modulation done. The magnet 108a has a magnetization direction corresponding to the positive z-direction, and the magnet 108b has a magnetization direction corresponding to the negative z-direction. In FIG. 6, a vertical axis represents the magnetic flux density Bz, and a horizontal axis represents a position of the magnetic scaler 108. “a.u.” stands for an arbitrary unit. In FIG. 6, a solid line represents the magnetic flux density obtained from the magnetic scaler as the comparative example, and a broken line represents an ideal sinusoidal waveform. As illustrated in FIG. 6, the ideal sinusoidal waveform cannot be obtained from the magnetic scaler 108, which is the comparative example. The same applies to arranging magnetic poles of the same strength, with the magnet width Lm and the magnet pitch Pm being fixed as in Patent Literature 1, in which case a long-period signal produced is not an ideal sinusoidal signal.

FIG. 7 is a diagram illustrating a waveform of magnetic flux density applied to the magnetic sensors 106 from the magnetic scaler 101 of the magnetic encoder 100 according to the first embodiment. In FIG. 7, a vertical axis represents the magnetic flux density Bz, and a horizontal axis represents the position of the magnetic scaler 101. In FIG. 7, a solid line represents the magnetic flux density obtained from the magnetic scaler 101, and a broken line represents the ideal sinusoidal waveform. As illustrated in FIG. 7, the waveform reproducing the ideal sinusoidal wave is obtained from the magnetic scaler 101 according to the first embodiment.

For a stroke of the magnetic scaler 101, a signal as long as one cycle needs to be generated for an absolute position of the magnetic scaler 101 to be detected. With the magnet groups 102 and 103, the magnetic scaler 101 according to the first embodiment enables the generation of a sinusoidal signal that is as long as one cycle, allowing for implementation of the magnetic encoder 100 capable of absolute position detection.

According to the first embodiment described above, since the magnet widths of the magnet groups 102 and 103 have been modulated to provide a one-cycle sinusoidal waveform, a smooth and long-period sinusoidal signal can be obtained, allowing for acquisition of continuous and highly accurate position data over a wide range. Furthermore, since the magnet groups 102 and 103 are arranged to generate the one-cycle sinusoidal waveform, the magnets have increased total volume, resulting in enhanced magnetic fields and higher signal strength.

### Second Embodiment

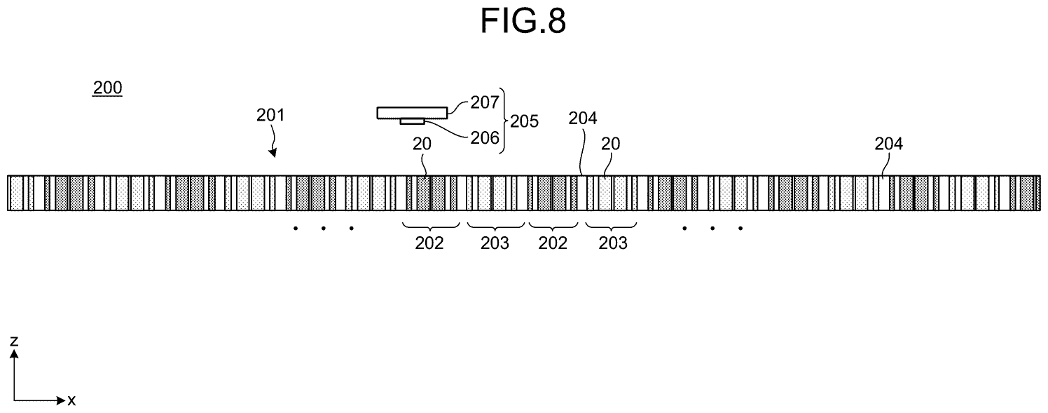

FIG. 8 is a front view illustrating a configuration of a magnetic encoder 200 according to a second embodiment. The magnetic encoder 200 according to the second embodiment includes a magnetic scaler 201 and a position detector 205 that detects magnetic fields generated from the magnetic scaler 201. The magnetic encoder 200 according to the second embodiment is a linear encoder. In the second embodiment, the magnetic scaler 201 is a stator, and the position detector 205 is a mover.

The magnetic scaler 201 includes: a plurality of magnet groups 202 as first magnet groups; a plurality of magnet groups 203 as second magnet groups; and a base body 204 that is made of a nonmagnetic material and holds the magnet groups 202 and 203 in place. In FIG. 8, a part of the base body 204 that is located under the magnet groups 202 and 203 is not illustrated to make clearer how magnets 20 are arranged. The position detector 205 includes: a magnetic sensor 206 that detects the magnetic fields generated from the magnetic scaler 201; and a substrate 207 to which the magnetic sensor 206 is attached.

In the magnetic scaler 201, the plurality of magnet groups 202 and the plurality of magnet groups 203 are alternately arranged in the x-direction. Every one of those magnets 20 forming the magnet groups 202 has a magnetization direction corresponding to the positive z-direction, and every one of those magnets 20 forming the magnet groups 203 has a magnetization direction corresponding to the negative z-direction. Each magnet group 202 and each magnet group 203 have the same number of magnets 20, which is at least three. A magnet pitch is constant for any adjacent magnets 20. Magnet widths increase and decrease according to a sin function. Each of the magnet widths is smaller than the magnet pitch.

In FIG. 8, the magnets 20 constituting every magnet group 202 are four in number and correspond to a range from 0 degrees to 180 degrees of the sin function. Each magnet width in each magnet group 202 is defined by a value obtained by multiplying an integral over a corresponding one of 45-degree divisions (four equal parts) of the sin function by a constant. The magnets 20 constituting every magnet group 203 are four in number and correspond to a range from 180 degrees to 360 degrees of the sin function. Each magnet width in each magnet group 203 is defined by a value obtained by multiplying an integral over a corresponding one of 45-degree divisions (four equal parts) of the sin function by a constant. The magnet widths increase from ends to a middle of each of the magnet groups 202 and 203 with respect to the x-direction.

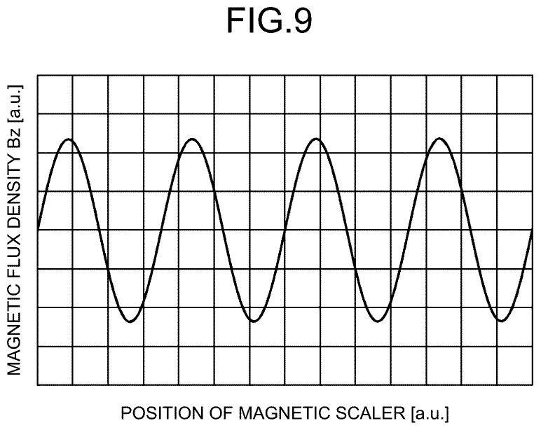

FIG. 9 is a diagram illustrating waveforms of magnetic flux density applied to the magnetic sensor 206 from the magnetic scaler 201 of the magnetic encoder 200 according to the second embodiment. In FIG. 9, a vertical axis represents the magnetic flux density Bz, and a horizontal axis represents a position of the magnetic scaler 201. FIG. 9 illustrates the magnetic flux density obtained from the magnetic scaler 201. The waveforms of the magnetic flux density illustrated in FIG. 9 correspond to four cycles of the magnet groups 202 and 203. As illustrated in FIG. 9, the waveforms reproducing ideal sinusoidal waves are obtained from the magnetic scaler 201 according to the second embodiment.

According to the second embodiment described above, the plurality of magnet groups 202 and 203 are arranged in pairs that each generate a one-cycle sinusoidal waveform; therefore, long-period sinusoidal signals can be obtained, allowing for acquisition of highly accurate absolute position data over a wider range. Furthermore, suppose that the magnetic scaler 201 of the second embodiment has the same length measured in the x-direction as the magnetic scaler 101 of the first embodiment. The magnetic scaler 201 covers plural cycles of sinusoidal waveforms for the same scale length, thus providing a sinusoidal signal of a short wavelength compared to the first embodiment. The shorter wavelength leads to improved accuracy of position detection and improved stability against output fluctuations. Furthermore, with the shorter wavelength, position detection variation is less significant and more stable in the presence of some output fluctuation equivalent to one degree of the sinusoidal signal.

### Third Embodiment

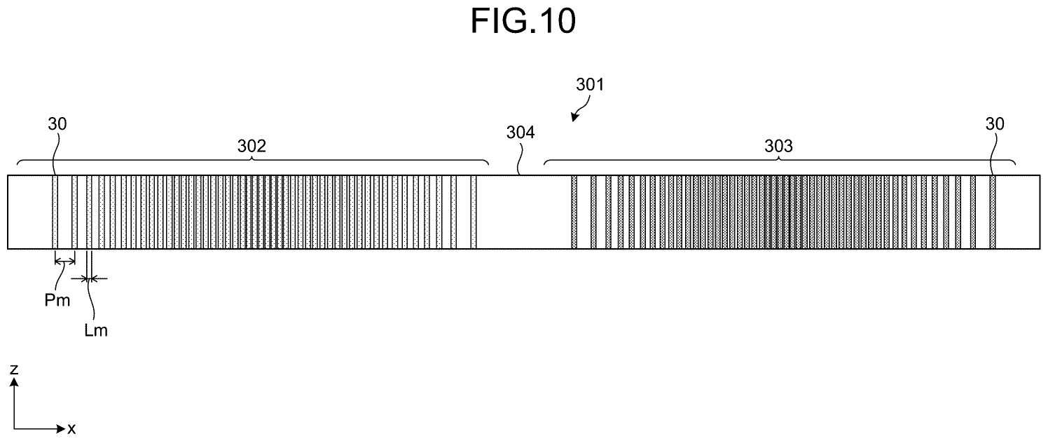

FIG. 10 is an enlarged front view illustrating a configuration of a magnetic scaler 301 of a magnetic encoder according to a third embodiment. A position detector of the magnetic encoder according to the third embodiment is the same as the position detector 105 of the first embodiment illustrated in FIGS. 1 to 3 and is not illustrated and described to omit redundancy. For the magnetic scaler 301 of the third embodiment, a magnet-pitch modulation method by which magnet pitches vary is used. The magnetic encoder according to the third embodiment is a linear encoder. In the third embodiment, the magnetic scaler 301 is a mover, and the position detector, which is not illustrated, is a stator.

The magnetic scaler 301 includes: a magnet group 302 having a plurality of magnets 30 as a first magnet group; a magnet group 303 having plural magnets 30 as a second magnet group; and a base body 304 that is made of a nonmagnetic material and holds the magnet groups 302 and 303 in place. In FIG. 10, a part of the base body 304 that is located above the magnet groups 302 and 303 is not illustrated to make clearer how the magnets 30 are arranged. Every magnet in the magnet group 302 has a magnetization direction corresponding to the positive z-direction, and every magnet in the magnet group 303 has a magnetization direction corresponding to the negative z-direction.

The magnet groups 302 and 303 have the same number of magnets 30, which is at least three. Each magnet 30 in the magnet group 302 and each magnet 30 in the magnet group 303 are set at a constant magnet width Lm.

In the third embodiment, the magnet pitches Pm for the magnets constituting the magnet group 302 increase and decrease according to a sin function. The magnet pitches Pm for the magnets 30 in the magnet group 302 are defined such that integrals of the sin function over the respective magnet pitches Pm are the same. In other words, with respect to the x-direction, the magnet pitches Pm for the magnets 30 are set to decrease from ends to a middle of the magnet group 302, with the middle corresponding to a maximum value of the sin function. Put differently, the magnet pitches Pm for the magnets 30 gradually decrease and then gradually increase in the magnet group 302. The magnet pitches Pm for the magnets 30 in the magnet group 303 are similarly defined such that integrals of the sin function over the respective magnet pitches Pm are the same. In other words, the magnet pitches Pm for the magnets 30 are set to decrease from ends to a middle of the magnet group 303. The magnet width Lm is smaller than the magnet pitch Pm for any magnets. In other words, each of the magnet pitches Pm is greater than the constant magnet width Lm.

According to the third embodiment described above, since the magnet pitches of the magnet groups 302 and 303 have been modulated to provide a one-cycle sinusoidal waveform, a smooth and long-period sinusoidal signal can be obtained, allowing for acquisition of continuous and highly accurate position data over a wide range. Furthermore, since the magnet groups 302 and 303 are arranged to generate the one-cycle sinusoidal waveform, the magnets have increased total volume, resulting in enhanced magnetic fields and higher signal strength. In addition, the magnetic encoder implemented is capable of absolute position detection.

### Fourth Embodiment

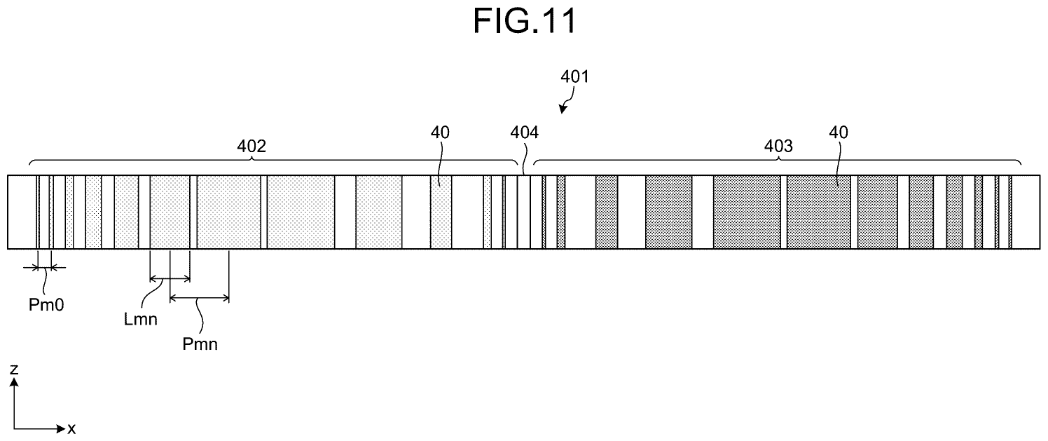

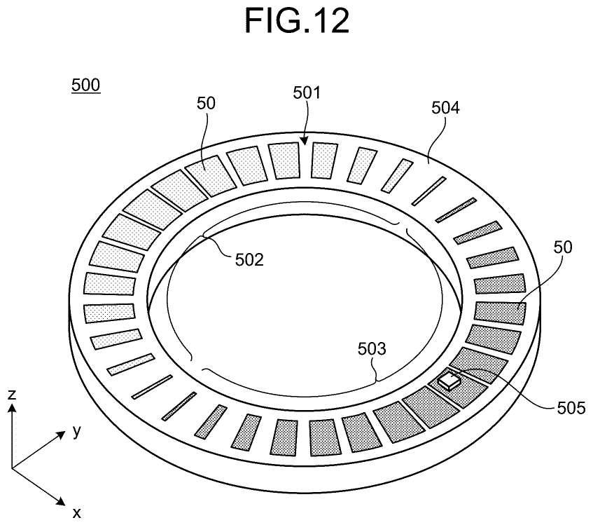

FIG. 11 is an enlarged front view illustrating a configuration of a magnetic scaler 401 of a magnetic encoder according to a fourth embodiment. A position detector of the magnetic encoder according to the fourth embodiment is the same as the position detector 105 of the first embodiment illustrated in FIGS. 1 to 3 and is not illustrated and described to omit redundancy. For the magnetic scaler 401 of the fourth embodiment, a magnet-width and magnet-pitch modulation method by which magnet widths and magnet pitches vary is used. The magnetic encoder according to the fourth embodiment is a linear encoder. In the fourth embodiment, the magnetic scaler 401 is a mover, and the position detector, which is not illustrated, is a stator.

The magnetic scaler 401 includes: a magnet group 402 having a plurality of (twelve) magnets 40 as a first magnet group; a magnet group 403 having a plurality of (twelve) magnets 40 as a second magnet group; and a base body 404 that is made of a nonmagnetic material and holds the magnet groups 402 and 403 in place. In FIG. 11, a part of the base body 404 that is located above the magnet groups 402 and 403 is not illustrated to make clearer how the magnets 40 are arranged. Every magnet in the magnet group 402 has a magnetization direction corresponding to the positive z-direction; and every magnet in the magnet group 403 has a magnetization direction corresponding to the negative z-direction. The magnet groups 402 and 403 have the same number of magnets 40, which is at least three.

In the fourth embodiment, the magnet widths Lmn and the magnet pitches Pmn for the magnets 40 of the magnet groups 402 and 403 both increase and decrease according to a sin function. “n” is an integer from 0 to 11 inclusive. The “n”-th magnet width Lmn is smaller than the “n”-th magnet pitch Pmn. In other words, the magnet width Lmn is smaller than the corresponding magnet pitch Pmn.

When the magnet pitches Pmn for the magnets 40 are set, the 0th magnet pitch Pm0 is set first, followed sequentially by the first magnet pitch Pm1, the second magnet pitch Pm2, . . . , and Pm11 according to the sin function. Pm1 to Pm11 are not illustrated in the drawing for convenience' sake. Each of the magnet widths Lmn is defined by a value obtained by multiplying an integral of the sin function over the corresponding magnet pitch Pmn by a constant. The magnet pitches Pmn for the magnets 40 are set to increase from ends to a middle of each of the magnet groups 402 and 403 with respect to the x-direction, and the magnet widths Lmn are set to increase from the ends to the middle. In other words, in each of the magnet groups 402 and 403, the magnet pitches Pmn for the magnets 40 gradually increase and then gradually decrease, and the magnet widths Lmn also gradually increase and then gradually decrease.

According to the fourth embodiment described above, since the magnet pitches of the magnet groups 402 and 403 have been modulated to provide a one-cycle sinusoidal waveform, a smooth and long-period sinusoidal signal can be obtained, allowing for acquisition of continuous and highly accurate position data over a wide range. Furthermore, since the magnet groups 402 and 403 are arranged to generate the one-cycle sinusoidal waveform, the magnets have increased total volume, resulting in enhanced magnetic fields and higher signal strength. In addition, the magnetic encoder implemented is capable of absolute position detection.

### Fifth Embodiment

FIG. 12 is a perspective view illustrating a configuration of a magnetic encoder according to a fifth embodiment. The magnetic encoder according to the fifth embodiment is a rotary encoder, and a magnet-width modulation method is adopted similarly to the first embodiment. The magnetic encoder 500 according to the fifth embodiment includes: a ring-shaped magnetic scaler 501; and a magnetic sensor 505 that detects magnetic fields generated from the magnetic scaler 501. In the fifth embodiment, the magnetic scaler 501 is a mover, and the magnetic sensor 505 is a stator.

The magnetic scaler 501 includes: a magnet group 502 as a first magnet group, a magnet group 503 as a second magnet group; and a base body 504 that is made of a nonmagnetic material and holds the magnet groups 502 and 503 in place. The magnetic scaler 501 is installed on a rotating shaft (not illustrated) and rotates. In the present disclosure, in the case of the rotary encoder, a circumferential direction that is a rotation direction of the magnetic scaler 501 corresponds to the first direction. The magnetic sensor 505 is fixed on a substrate (not illustrated) at a given distance from the magnetic scaler 501 in the z-direction. The magnetic sensor 505 detects a position of the magnetic scaler 501 on the basis of the magnetic fields that shift as the magnetic scaler 501 rotates.

The magnetic scaler 501 includes: the magnet group 502 having a plurality of (sixteen) magnets 50 that are arranged in the circumferential direction; the magnet group 503 having a plurality of (sixteen) magnets 50 that are arranged in the circumferential direction; and the base body 504, which is made of the nonmagnetic material and holds the magnet groups 502 and 503 in place. Every magnet in the magnet group 502 has a magnetization direction pointing from its inside-diameter side to its outside-diameter side; and every magnet in the magnet group 503 has a magnetization direction pointing from its outside-diameter side to its inner-circumference side. The magnet groups 502 and 503 have the same number of magnets 50, which is at least three.

A magnet pitch is constant for any adjacent magnets 50 in the magnet groups 502 and 503. In each of the magnet groups 502 and 503, magnet widths increase and decrease according to a sin function similarly to the first embodiment. In other words, the magnet widths increase from ends to a middle of each of the magnet groups 502 and 503 with respect to the circumferential direction. Put differently, the magnet widths gradually increase and then gradually decrease in each of the magnet groups 502 and 503. However, each of the magnet widths is smaller than the magnet pitch. In other words, even the greatest magnet width is smaller than the constant magnet pitch for the magnets 50.

It is to be noted that the magnet-pitch modulation method shown in the third embodiment or the magnet-width and magnet-pitch modulation method shown in the fourth embodiment may be applied to the magnetic rotary encoder according to the fifth embodiment.

According to the fifth embodiment, since the magnet widths of the magnet groups 502 and 503 have been modulated to provide a one-cycle sinusoidal waveform, a smooth and long-period sinusoidal signal can be obtained, allowing for the implementation of the magnetic rotary encoder capable of obtaining continuous and highly accurate position data over a wide range. Furthermore, since the magnet groups 502 and 503 are arranged to generate the one-cycle sinusoidal waveform, the magnets have increased total volume, resulting in enhanced magnetic fields and higher signal strength. In addition, the magnetic rotary encoder implemented is capable of absolute position detection.

While the magnet widths or the magnet pitches vary to generate a sinusoidal magnetic field variation in the first through fifth embodiments, magnetic forces of the magnets may vary, with the magnet widths and the magnet pitches being uniform, to generate a sinusoidal magnetic field variation. Methods for the magnetic forces to vary include gradually changing thicknesses of the magnets, gradually changing distance from the magnetic sensor, gradually changing magnetization rates of the magnets, and gradually changing magnetic materials of the magnets.

The term “move” herein encompasses both linear movement and rotational movement.

The above configurations illustrated in the embodiments are illustrative of contents of the present disclosure, can be combined with other techniques that are publicly known, and can be partly omitted or changed without departing from the gist of the present disclosure.

### REFERENCE SIGNS LIST

10, 20, 30, 40, 50, 108a, 108b magnet; 100, 200, 500 magnetic encoder; 101, 108, 201, 301, 401, 501 magnetic scaler; 102, 103, 202, 203, 302, 303, 402, 403, 502, 503 magnet group; 104, 204, 304, 404, 504 base body; 105, 205 position detector; 106, 206, 505 magnetic sensor; 107, 207 substrate; Lm, Lmn magnet width; Pm, Pm0, Pm1, Pm2, Pmn magnet pitch.

1. A magnetic encoder comprising a magnetic scaler and a position detector configured to move relative to each other, wherein
the magnetic scaler includes:
a first magnet group where at least three magnets having an identical first magnetization direction are arranged in a first direction; and
a second magnet group where at least three magnets, each having a second magnetization direction opposite to the first magnetization direction, are arranged in the first direction, where the second magnet group is adjacent to the first magnet group in the first direction, wherein
the position detector includes a magnetic sensor configured to detect a magnetic field generated from the magnetic scaler, wherein
in the first magnet group, magnet widths are configured to increase from ends to a middle of the first magnet group and each of the magnet width is smaller than a magnet pitch; and
in the second magnet group, magnet widths are configured to increase from ends to a middle of the second magnet group and each of the magnet width is smaller than the magnet pitch.

2. The magnetic encoder according to claim 1, wherein
the first magnet group and the second magnet group of the magnetic scaler have the same magnet pitch, and the magnet widths of each of the first magnet group and the second magnet group are configured to vary according to a sinusoidal function.

3. A magnetic encoder comprising a magnetic scaler and a position detector configured to move relative to each other, wherein
the magnetic scaler includes:
a first magnet group where at least three magnets having an identical first magnetization direction are arranged in a first direction; and
a second magnet group where at least three magnets, each having a second magnetization direction opposite to the first magnetization direction, are arranged in the first direction, where the second magnet group is adjacent to the first magnet group in the first direction, wherein
the position detector includes a magnetic sensor configured to detect a magnetic field generated from the magnetic scaler, wherein
in the first magnet group, magnet pitches are configured to decrease from ends to a middle of the first magnet group and each of the magnet pitch is greater than a magnet width; and
in the second magnet group, magnet pitches are configured to decrease from ends to a middle of the second magnet group and each of the magnet pitch is greater than a magnet width.

4. The magnetic encoder according to claim 3, wherein
the first magnet group and the second magnet group of the magnetic scaler have the same magnet width, and the magnet pitches of each of the first magnet group and the second magnet group vary according to a sinusoidal function.

5. A magnetic encoder comprising a magnetic scaler and a position detector configured to move relative to each other, wherein
the magnetic scaler includes:
a first magnet group where at least three magnets having an identical first magnetization direction are arranged in a first direction; and
a second magnet group where at least three magnets, each having a second magnetization direction opposite to the first magnetization direction, are arranged in the first direction, where the second magnet group is adjacent to the first magnet group in the first direction,
the position detector includes a magnetic sensor configured to detect a magnetic field generated from the magnetic scaler, wherein
in the first magnet group, magnet widths are configured to increase from ends to a middle of the first magnet group, and magnet pitches are configured to increase from the ends to the middle, where each of the magnet widths is smaller than a corresponding one of the magnet pitches; and
in the second magnet group, magnet widths are configured to increase from ends to a middle of the second magnet group, and magnet pitches are configured to increase from the ends to the middle, where each of the magnet widths is smaller than a corresponding one of the magnet pitches.

6. The magnetic encoder according to claim 5, wherein
the magnet widths and the magnet pitches of each of the first magnet group and the second magnet group of the magnetic scaler both vary according to a sinusoidal function.

7. The magnetic encoder according to claim 1, wherein
a length of the first magnet group in the first direction, and a length of the second magnet group in the first direction, correspond to a half wavelength of a sinusoidal waveform.

8. The magnetic encoder according to claim 1, wherein
the magnetic scaler is disposed as a stator, and the position detector is disposed as a mover, and
a plurality of the first magnet groups and a plurality of the second magnet groups are arranged in the first direction.

9. The magnetic encoder according to claim 1, wherein
the position detector is disposed as a stator, and the magnetic scaler is disposed as a mover, and
a plurality of the magnetic sensors are arranged in the first direction.

10. The magnetic encoder according to claim 1, wherein
the magnetic encoder is a linear encoder.

11. The magnetic encoder according to claim 1, wherein
the magnetic encoder is a rotary encoder.
